(19) United States
(12) Patent Application Publication
(10) Pub. No.: US 2012/0219337 A1
(43) Pub. Date: Aug. 30, 2012

(54) SHEET DETECTING APPARATUS AND IMAGE FORMING APPARATUS

(75) Inventor: Terutaka Endo, Odawara-shi (JP)

(73) Assignee: CANON KABUSHIKI KAISHA, Tokyo (JP)

(21) Appl. No.: 13/399,182

(22) Filed: Feb. 17, 2012

(30) Foreign Application Priority Data
Feb. 25, 2011 (JP) 2011-039354

(51) Int. Cl. B65H 5/00; G03G 15/00

(52) U.S. Cl. 399/381; 271/264

(57) ABSTRACT

The present invention reduces chattering of a sensor flag at a home position and alleviates a collision noise of the sensor flag with a simple configuration. A sheet detecting apparatus includes a turning portion, a sensor outputting a detection signal in response to turning of the turning portion to the detecting position, a first sliding contact portion sliding in contact with the protruded portion so as to move relatively to the protruded portion in an axial direction of the turning portion when the turning portion returns from the detecting position to the home position, and a second sliding contact portion sliding in contact with the protruded portion so as to move relatively to the protruded portion in the axial direction of the turning portion when the turning portion turns from the home position to the detecting position.

### BACKGROUND OF THE INVENTION

1. Field of the Invention

The present invention relates to a sheet detecting apparatus and an image forming apparatus.

2. Description of the Related Art

Conventionally, as a method for confirming a conveyance position of a recording medium (sheet) in an apparatus, the recording medium, which is being conveyed, directly contacts and swings a sensor flag arranged in a conveyance path. Positional information of the recording medium is thereby detected from ON/OFF signal information of a sensor such as a photo interrupter. Such a method is generally known.

In such a contact-type sensing configuration, when the swung sensor flag returns to a standby position (hereinafter referred to as “a home position”), the sensor flag collides with an opposed positioning member. This may generate a harsh collision noise or a detection error caused by erroneous detection of the sensor due to bounce of the sensor flag, that is, chattering.

Also, by inclining the abutting surface of the sensor flag as in U.S. Pat. No. 5,923,140 or forming the cross section of the receiving surface 501a with which the positioning abutting portion 1d of the sensor flag 1 collides in the V shape as illustrated in FIGS. 13A and 13B, the chattering is reduced, and the detection error is improved. However, the inclined abutting surface of the sensor flag abuts on the positioning member. In another example, the positioning abutting portion 1d of the sensor flag 1 collides with two inclined surfaces forming the cross-sectional V shape of the receiving surface 501a. Thus, kinetic energy of the sensor flag is converted into sound energy precipitously and is radiated outside as a collision noise, which generates an aurally harsh noise.

Also, in Japanese Patent Laid-Open No. 2007-297190, a sheet detecting lever has an abutting surface. After a sheet material passes, the sheet detecting lever is brought back from a retracting position while the sheet material is passing to an original position. At this time, the abutting surface abuts on another member to return to the original position. When the abutting surface of the sheet detecting lever slides in contact with the another member, the sheet detecting lever moves in an axial direction of the sheet detecting lever. A spring applies a force to the sheet detecting lever in an axial direction so that the abutting surface of the sheet detecting lever and the another member contact with each other at any time. Therefore the sheet detecting lever is hard to move.

The present invention reduces chattering of a sensor flag at a home position and alleviates a collision noise of the sensor flag with a simple configuration.

### SUMMARY OF THE INVENTION

According to the present invention, a sheet detecting apparatus includes a turning portion turning from a home position to a detecting position by being pressed by a conveyed sheet and having a protruded portion protruded in a radial direction, a sensor outputting a detection signal in response to turning of the turning portion to the detecting position, a first sliding contact portion sliding in contact with the protruded portion so as to move relatively to the protruded portion in an axial direction of the turning portion when the turning portion returns from the detecting position to the home position, and a second sliding contact portion sliding in contact with the protruded portion so as to move relatively to the protruded portion in the axial direction of the turning portion when the turning portion turns from the home position to the detecting position.

Further features of the present invention will become apparent from the following description of exemplary embodiments with reference to the attached drawings.

### BRIEF DESCRIPTION OF THE DRAWINGS

FIG. 1 is a cross-sectional view illustrating a configuration of an image forming apparatus having a sheet detecting apparatus according to the present invention;

FIG. 2 is a perspective view illustrating a configuration of a first embodiment of the sheet detecting apparatus according to the present invention;

FIG. 3A is a front view illustrating a state in which a positioning abutting portion abuts on a first guide surface in a state in which a sensor flag is at a home position, and FIG. 3B is a front view illustrating a state in which the positioning abutting portion abuts on a second guide surface in a process in which the sensor flag moves from the home position to a detecting position in the first embodiment;

FIG. 4A is a front view illustrating a state in which the positioning abutting portion abuts on the second guide surface in a state in which the sensor flag is at the detecting position, and FIG. 4B is a front view illustrating a state in which the positioning abutting portion abuts on the first guide surface in a process in which the sensor flag moves from the detecting position to the home position in the first embodiment;

FIG. 5A is a front view illustrating a state in which the positioning abutting portion abuts on a surface, having a smaller inclination angle, of the first guide surface as the sensor flag moves closer to the home position in the process in which the sensor flag moves from the detecting position to the home position, and FIG. 5B is a front view illustrating a track on which the positioning abutting portion slides in contact with the first and second guide surfaces in a process in which the sensor flag moves from the home position to the detecting position and further moves to the home position in the first embodiment;

FIGS. 6A and 6B are front views illustrating examples in cases of forming the second guide surface in other shapes in the first embodiment;

FIG. 7A is a perspective view illustrating a configuration of a second embodiment of the sheet detecting apparatus according to the present invention in a state in which the sensor flag is at the home position, FIG. 7B is a front view illustrating a state in which the positioning abutting portion of the sensor flag abuts on a positioning surface in a state of being at the home position, FIG. 7C is a schematic cross-sectional view illustrating a configuration in a state in which a positional approximating member thrusting the sensor flag in a second axial direction is at the home position; and

FIG. 8A is a perspective view illustrating a configuration of the second embodiment of the sheet detecting apparatus according to the present invention in a state in which the sensor flag is at the detecting position, FIG. 8B is a front view illustrating a state in which the positioning abutting portion of the sensor flag abuts on the first guide surface in a state of being at the detecting position, and FIG. 8C is a schematic cross-sectional view illustrating a configuration in a state in which the positional approximating member thrusting the sensor flag in the second axial direction is at the detecting position; and

FIGS. 9A and 9B are perspective views illustrating configurations of a reference example of the sheet detecting apparatus, and FIG. 9A illustrates a state in which the sensor flag is at the home position and FIG. 9B illustrates a state in which the sensor flag is at the detecting position;

FIG. 10 is a perspective view illustrating another configuration of the reference example of the sheet detecting apparatus;

FIG. 11 is a perspective view illustrating a modification example of the first embodiment;

FIG. 12A is a schematic view illustrating a configuration of the modification example illustrated in FIG. 11 in a state in which the sensor flag is at the home position, FIG. 12B is a schematic view illustrating a state in which the sensor flag is turning from the home position to the detecting position in the modification example illustrated in FIG. 11, and FIG. 12C is a schematic view illustrating a state in which the sensor flag is turning from the detecting position to the home position in the modification example illustrated in FIG. 11; and

FIG. 13 illustrates a conventional example.

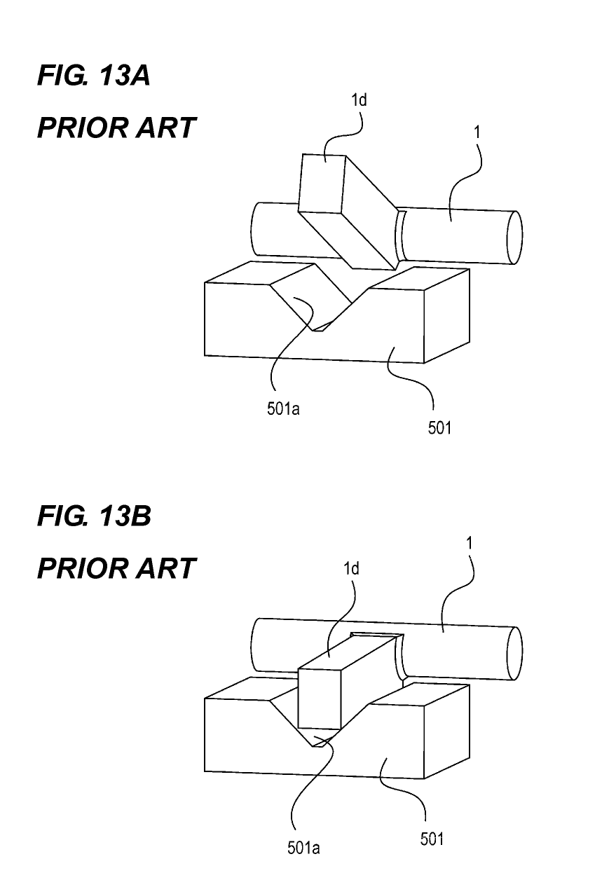

### DESCRIPTION OF THE EMBODIMENTS

An embodiment of a sheet detecting apparatus according to the present invention and an image forming apparatus having the same will be described specifically with reference to the drawings.

### First Embodiment

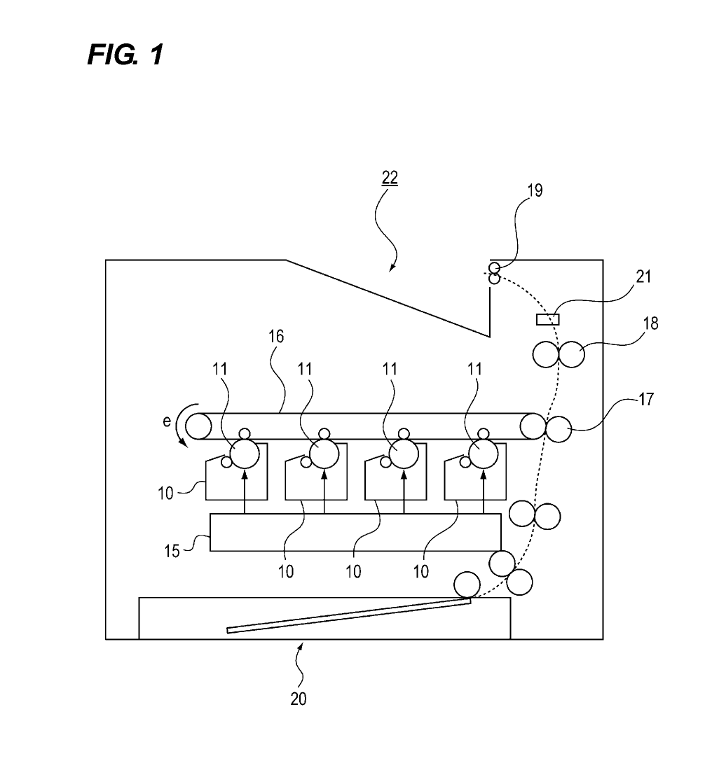

First, a first embodiment of an image forming apparatus having a sheet detecting apparatus according to the present invention will be described with reference to FIGS. 1 to 6.

### <Image Forming Apparatus>

FIG. 1 is a cross-sectional view illustrating an image forming apparatus 22 such as a printer having a sheet detecting apparatus 21 according to the present invention. This image forming apparatus 22 adopts a so-to-speak tandem system, in which four image forming units 10, each of which is an image forming portion to form an image with one of Y (yellow), M (magenta), C (cyan), and K (black) on a recording medium S as a sheet, are arranged in parallel in a horizontal direction.

Each of the image forming units 10 has a photosensitive drum 11, an electric charger, and a development device. From a laser scanning optical unit 15, a laser beam modulated based on image data is emitted to each photosensitive drum 11, and an electrostatic latent image is formed on the photosensitive drum 11. Directly above the image forming units 10, an intermediate transfer belt 16 is arranged so as to be rotatable in the arrow e direction in FIG. 1, and toner images formed on the respective photosensitive drums 11 are primarily transferred on the intermediate transfer belt 16 and are synthesized into a color image.

On the lower level of the image forming apparatus 22, a cassette feeding apparatus 20 housing the recording medium S is arranged. The recording medium S fed from the cassette feeding apparatus 20 is conveyed and nipped between the intermediate transfer belt 16 and a secondary transfer roller 17, and the toner images on the intermediate transfer belt 16 are secondarily transferred to the recording medium S. The recording medium S thereafter undergoes heat-fixing of the toner images at a fixing unit 18 and is discharged to an upper surface of the image forming apparatus 22 from a discharge roller 19. On a conveyance path between the fixing unit 18 and the discharge roller 19, the sheet detecting apparatus 21 is provided, to be described below in details, which detects the recording medium S conveyed on the conveyance path.

Meanwhile, in FIG. 1, the sheet detecting apparatus 21 is configured to detect the recording medium S on which the toner images have been fixed. A place to install the sheet detecting apparatus 21 is not limited as long as the place is on a conveyance path from a point at which the recording medium S is fed from the cassette feeding apparatus 20 to a point at which the recording medium S is discharged from the discharge roller 19.

### <Sheet Detecting Apparatus>

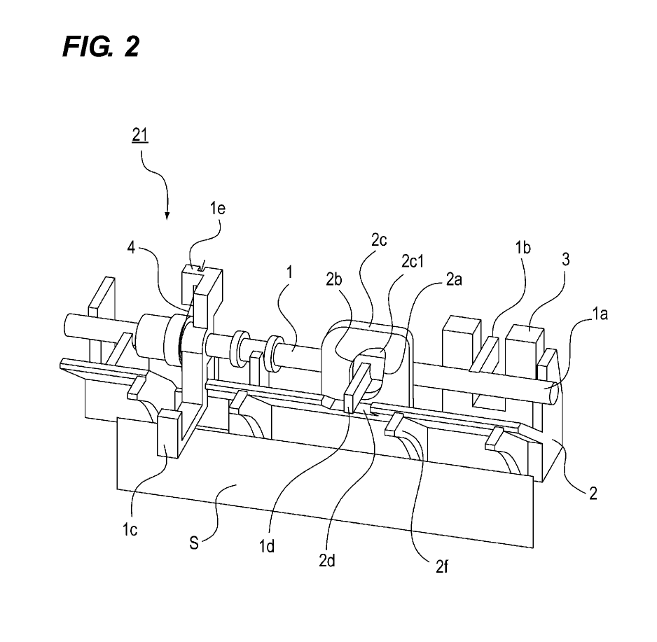

FIG. 2 illustrates a configuration of a first embodiment of a sheet detecting apparatus according to the present invention. In FIG. 2, in a conveying apparatus conveying the recording medium S such as a sheet, a conveying guide 2 guiding the conveyance of the recording medium S is provided. The conveying guide 2 is provided with a sensor flag 1 as a turning portion. The sensor flag 1 is supported to be rotatable by a not illustrated bearing member and to be movable in a direction along a rotation axis 1a. The sensor flag 1 contacts the recording medium S and is rotated and swung centering on the rotation axis 1a to detect a conveying state of the recording medium S. The sensor flag 1 is also movable in a direction along the rotation axis 1a (rotation axial direction).

The conveying guide 2 is provided with a light transmissive photo sensor 3. The photo sensor 3 outputs a detection signal in response to turning of the sensor flag 1 as a turning portion to a detecting position. A sensor shielding portion 1b of the sensor flag 1, provided at the conveying guide 2 to be rotatable centering on the rotation axis 1a and to be movable in the direction of the rotation axis 1a, is turned centering of the rotation axis 1a between a light emitting portion and a light receiving portion of the photo sensor 3 and shields the light path to turn ON/OFF the photo sensor 3.

The sensor flag 1 is provided with a contact portion 1c, which can contact the recording medium S conveyed along a guide rib 2f in the conveying apparatus. The recording medium S conveyed in the conveying apparatus contacts the contact portion 1c and presses and rotates the sensor flag 1 centering on the rotation axis 1a, and the shielding portion 1b transmits and shields light on the light path between the light emitting portion and the light receiving portion of the photo sensor 3 to turn ON/OFF the photo sensor 3. Accordingly, a passing state of the recording medium S can be detected.

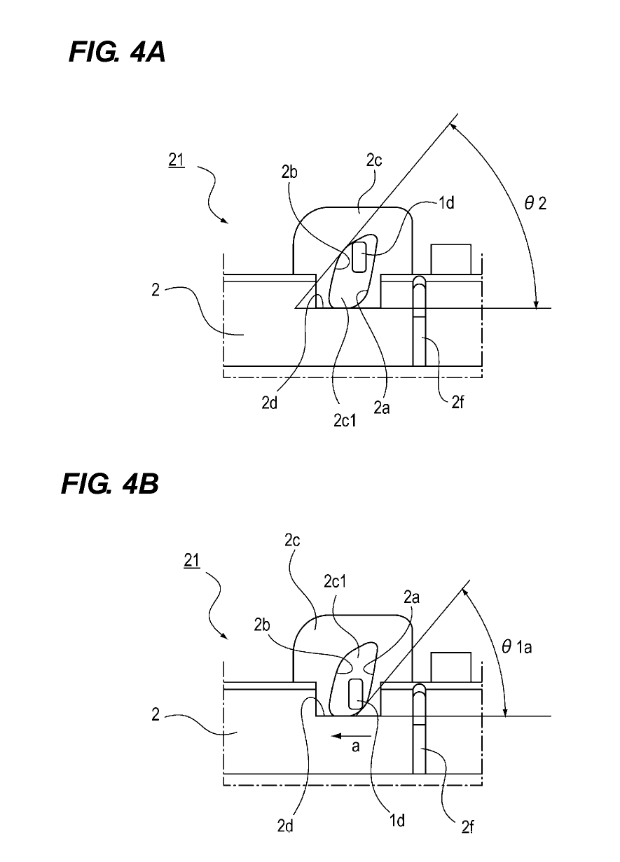

The conveying guide 2, which guides conveyance of the recording medium S, is provided with a first guide surface (first sliding contact portion) 2a moving the sensor flag 1 in a first axial direction (arrow a direction illustrated in FIG. 4B) along the rotation axis 1a.

The conveying guide 2, which guides conveyance of the recording medium S, is provided with a first guide surface (first sliding contact portion) 2a moving the sensor flag 1 in a first axial direction (arrow a direction illustrated in FIG. 4B) along the rotation axis 1a.

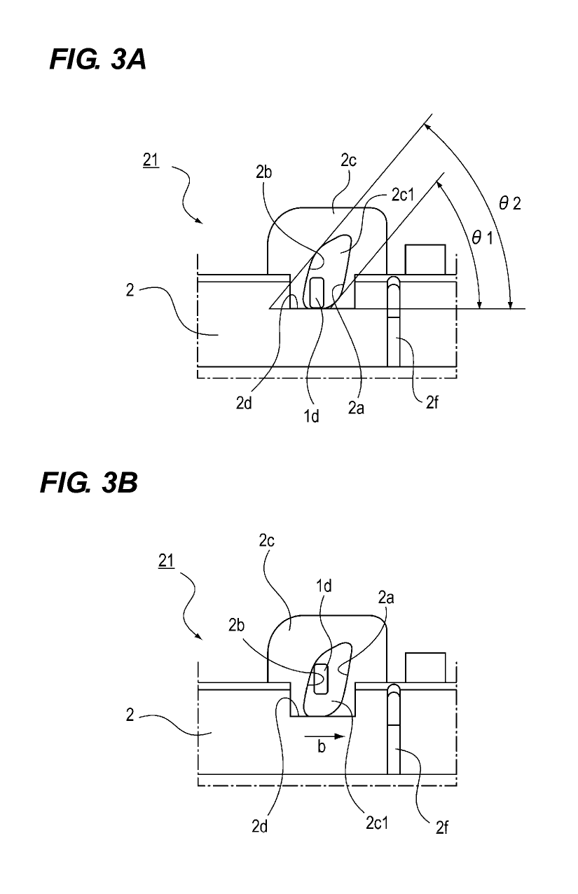

When the sensor flag 1 moves from the detecting position illustrated in FIG. 4A, in which the sensor flag 1 contacts the recording medium S, to a home position illustrated in FIGS. 2 and 3A, in which the sensor flag 1 does not contact the recording medium S, the sensor flag 1 slides in contact with the first guide surface 2a. Subsequently, the sensor flag 1 is moved in the first axial direction (arrow a direction illustrated in FIG. 4B) along the rotation axis 1a.

The conveying guide 2 is further provided with a second guide surface (second sliding contact portion) 2b moving the sensor flag 1 in a second axial direction (arrow b direction illustrated in FIG. 3B) along the rotation axis 1a, which is an opposite direction of the first axial direction (arrow a direction illustrated in FIG. 4B) along the rotation axis 1a.

When the sensor flag 1 moves from the home position illustrated in FIGS. 2 and 3A, in which the sensor flag 1 does not contact the recording medium S, to the detecting position illustrated in FIG. 4A, in which the sensor flag 1 contacts the recording medium S, the sensor flag 1 slides in contact with the second guide surface 2b. Subsequently, the sensor flag 1 is moved in the second axial direction (arrow b direction illustrated in FIG. 3B) along the rotation axis 1a, which is an opposite direction of the first axial direction (arrow a direction illustrated in FIG. 4B) along the rotation axis 1a.

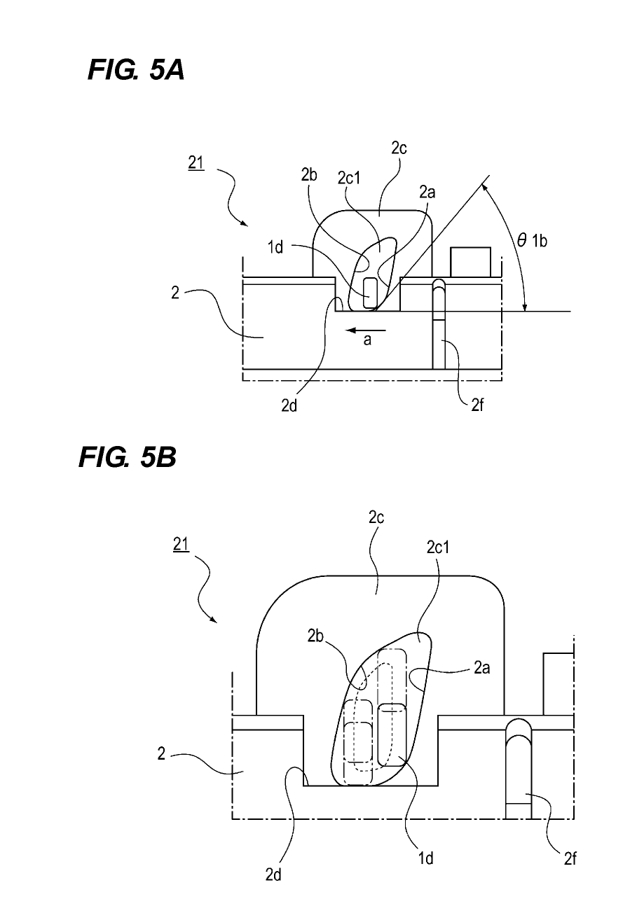

The first guide surface 2a and the second guide surface 2b have surfaces inclined to the direction of the rotation axis 1a (right-left direction in FIG. 2) of the sensor flag 1. As for the first guide surface 2a, an inclination angle θ1 to the rotation axial direction (right-left direction in FIG. 2) of the rotation axis 1a of the sensor flag 1 is set to be smaller as the sensor flag 1 moves closer to the home position. For example, an inclination angle θ1a illustrated in FIG. 4B is set to be larger than an inclination angle θ1b illustrated in FIG. 5A, at which the sensor flag 1 is closer to the home position.

The first and second guide surfaces 2a and 2b of the present embodiment are formed by an opening edge portion of a through hole 2c1 formed in a shape similar to “a hysteresis curve” provided in a plate-shaped member 2c provided on the conveying guide 2 in an upright state and are formed by mutually continuous annular curves. The sensor flag 1 is provided with the abutting portion 1d as the protruded portion protruded in the radial direction. The positioning abutting portion 1d provided on the sensor flag 1 passes through the through hole 2c1 provided in the plate-shaped member 2c of the conveying guide 2, and the positioning abutting portion 1d slides along and in contact with the first and second guide surfaces 2a and 2b in the through hole 2c1 as illustrated in FIG. 5B.

FIG. 3A illustrates a position of the positioning abutting portion 1d at the home position, in which the contact portion 1c of the sensor flag 1 does not slide in contact with the recording medium S. FIG. 3B illustrates a position of the positioning abutting portion 1d when the contact portion 1c of the sensor flag 1 slides in contact with the recording medium S, and when the sensor flag 1 starts to be pressed and rotated centering on the rotation axis 1a and is in the middle of moving from the home position to the detecting position.

Also, FIG. 4A illustrates a position of the positioning abutting portion 1d at the detecting position, in which the contact portion 1c of the sensor flag 1 slides in contact with the recording medium S. Each of FIGS. 4B and 5A illustrates a position of the positioning abutting portion 1d when the contact portion 1c of the sensor flag 1 slides in contact with the recording medium S and is in the middle of moving from the detecting position to the home position.

The first guide surface 2a illustrated in FIGS. 2 to 5 is formed by a curve protruded downward, and the inclination angle θ1 of the first guide surface 2a to the direction of the rotation axis 1a of the sensor flag 1 is set to be gradually smaller as the sensor flag 1 moves closer to the home position from the top to the bottom of FIG. 3A.

Also, the second guide surface 2b illustrated in FIGS. 2 to 5 is formed by a curve protruded upward, and an inclination angle θ2 of the second guide surface 2b to the direction of the rotation axis 1a of the sensor flag 1 is set to be gradually smaller as the sensor flag 1 moves closer to the detecting position from the bottom to the top of FIG. 4A.

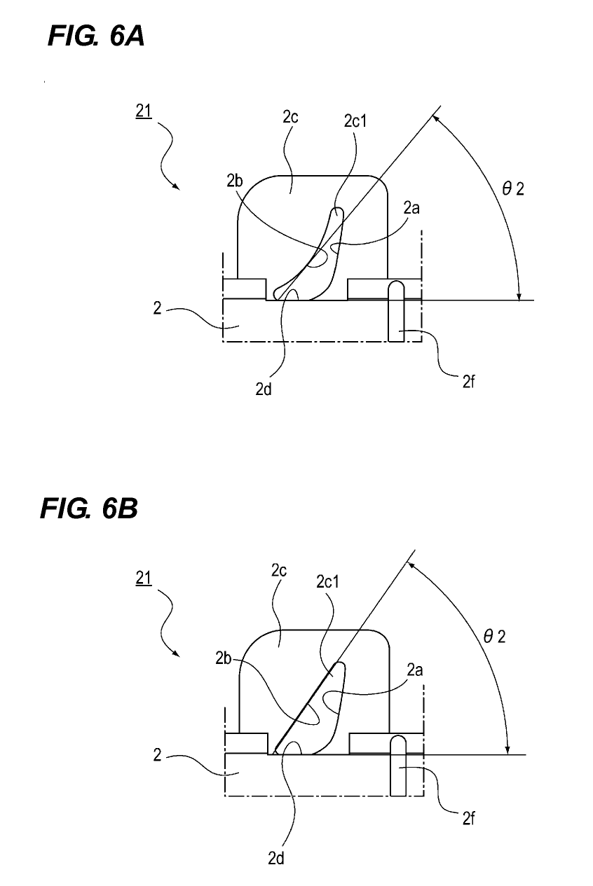

The second guide surfaces 2b illustrated in FIGS. 6A and 6B are examples of other configurations. The second guide surface 2b illustrated in FIG. 6A is formed by a curve protruded downward, and the inclination angle θ2 of the second guide surface 2b to the direction of the rotation axis 1a of the sensor flag 1 is set to be gradually larger as the sensor flag moves closer to the detecting position from the bottom to the top of FIG. 6A. The second guide surface 2b illustrated in FIG. 6B is linear and is an example in which the inclination angle θ2 of the second guide surface 2b to the direction of the rotation axis 1a of the sensor flag 1 is set to 55° or so. It is to be noted that the inclination angle θ2 of the second guide surface 2b to the direction of the rotation axis 1a of the sensor flag 1 is not limited to these, and the second guide surface 2b can be formed in a linear or curved shape having various angles.

In above description, the inclination angle θ1 of the first guide surface 2a to the direction of the rotation axis 1a of the sensor flag 1 is set to be gradually smaller as the sensor flag 1 moves closer to the home position from the top to the bottom of FIG. But the first guide surface 2a can be formed in a linear.

A torsion coil spring 4 is fitted to the rotation axis 1a, and one end portion thereof is locked by a spring holding portion 1e of the sensor flag 1 while the other end is locked by a part of the conveying guide 2. An elastic force by expansion of the torsion coil spring 4 is set to act in a direction opposite to a direction in which the recording medium S contacts the contact portion 1c of the sensor flag 1 and presses and rotates the contact portion 1c centering on the rotation axis 1a and applies a rotational load to the sensor flag 1. When the recording medium S is detached from the contact portion 1c of the sensor flag 1, the sensor flag 1 is rotated centering on the rotation axis 1a by the elastic force by expansion of the torsion coil spring 4 and returns to the home position as illustrated in FIGS. 2 and 3A.

FIG. 2 illustrate a state immediately before the recording medium S conveyed along the conveying guide 2 abuts on the contact portion 1c of the sensor flag 1, and a posture position of the sensor flag 1 at this time is the home position.

Thereafter, the recording medium S presses up the contact portion 1c of the sensor flag 1, at the same time of which the sensor shielding portion 1b is rotated and swung centering on the rotation axis 1a to switch a state of the photo sensor 3 from a light shielding state to a light transmitting state. A front end position of the recording medium S can be detected in receipt of an OFF/ON change of an electric signal of this photo sensor 3. A posture position when an electric signal of the photo sensor 3 is in an ON state is the detecting position.

Next, a position and a posture of the positioning abutting portion 1d in the process in which the sensor flag 1 moves from the home position illustrated in FIGS. 2 and 3A to the detecting position illustrated in FIG. 4A will be described. FIGS. 3A to 5A illustrate a moving state of the positioning abutting portion 1d of the sensor flag 1 and illustrate the plate-shaped member 2c, whose through hole 2c1 allows the positioning abutting portion 1d illustrated in FIG. 2 to pass therethrough, seen approximately from the front.

As illustrated in FIGS. 3A, 3B, and 4A, there is a process in which the positioning abutting portion 1d of the sensor flag 1 moves from the home position illustrated in FIGS. 2 and 3A to the detecting position illustrated in FIG. 4A. In this process, the positioning abutting portion 1d of the sensor flag 1 moves along the second guide surface 2b provided in the plate-shaped member 2c of the conveying guide 2 along with a rotating movement of the sensor flag 1 centering on the rotation axis 1a. Subsequently, the positioning abutting portion 1d moves in an upward direction in FIGS. 3 and 4A and in a right direction of the rotation axis 1a as the second axial direction (arrow b direction in FIG. 3B) and keeps in dynamic equilibrium at the detecting position illustrated in FIG. 4A.

Next, a position and a posture of the positioning abutting portion 1d in the process in which the sensor flag 1 moves from the detecting position illustrated in FIG. 4A to the home position illustrated in FIGS. 2 and 3A will be described.

When the recording medium S is further conveyed, and the rear end of the recording medium S passes the contact portion 1c of the sensor flag 1, the sensor flag 1 performs a rotating operation to the home position illustrated in FIGS. 2 and 3A by weight of the contact portion 1c itself and in receipt of the elastic force by expansion of the torsion coil spring 4.

At this time, as illustrated in FIGS. 4A, 4B, 5A, and 3A, the positioning abutting portion 1d of the sensor flag 1 moves along the first guide surface 2a provided in the plate-shaped member 2c of the conveying guide 2. The positioning abutting portion 1d slides on the inclined surface of the first guide surface 2a while moving in a downward direction in FIGS. 4B and 5A and in a left direction of the rotation axis 1a as the first axial direction (arrow a direction in FIGS. 4B and 5A). Subsequently, the positioning abutting portion 1d lands on a positioning surface 2d provided on the conveying guide 2 and returns to the home position illustrated in FIG. 3A.

As for an inclination of the first guide surface 2a provided in the through hole 2c1 of the plate-shaped member 2c of the conveying guide 2, the inclination angle θ1 can be smaller as the positioning abutting portion 1d moves closer to the positioning surface 2d as the home position as illustrated in FIGS. 4B and 5A. That is, the inclination angle θ1b illustrated in FIG. 5 is smaller than the inclination angle θ1a illustrated in FIG. 4B.

The inclination angle θ1a illustrated in FIG. 4B is an inclination angle of a tangent to the first guide surface 2a at a part at which the positioning abutting portion 1d abuts on the first guide surface 2a with respect to the direction of the rotation axis 1a. The inclination angle θ1b illustrated in FIG. 5A is an inclination angle of a tangent to the first guide surface 2a at a part at which the positioning abutting portion 1d abuts on the first guide surface 2a with respect to the direction of the rotation axis 1a.

By forming the first guide surface 2a in such a shape, the positioning abutting portion 1d slides on and frictions the first guide surface 2a, and a braking force acts. In addition, the positioning abutting portion 1d drops in a vertical direction from the position in FIG. 4A to the position in FIG. 4B. At this time, when the positioning abutting portion 1d collides with the first guide surface 2a forming an inclined surface, sound energy at the time of collision distributed in the vertical direction and in the direction of the rotation axis 1a can be converted into kinetic energy which moves the sensor flag 1 in the first axial direction (arrow a direction in FIG. 4B) along the rotation axis 1a.

Thus, chattering can be prevented, and a collision noise of the sensor flag 1 at the positioning abutting portion 1d can be further alleviated. Also, since the end portion of the first guide surface 2a is formed in an arc so that the positioning abutting portion 1d can move smoothly from the first guide surface 2a to the positioning surface 2d, a collision noise when the positioning abutting portion 1d moves in the direction of the rotation axis 1a can be alleviated as well.

In this manner, the positioning abutting portion 1d of the sensor flag 1 slides along and in contact with the first and second guide surfaces 2a and 2b formed by the circumference of the through hole 2c1 of the plate-shaped member 2c of the conveying guide 2 and the positioning surface 2d of the conveying guide 2. Thus, the positioning abutting portion 1d follows the track as illustrated in FIG. 5B. At the time of moving from the detecting position illustrated in FIG. 4A to the home position illustrated in FIG. 3A, the positioning abutting portion 1d can definitely start abutting on the inclined surface of the first guide surface 2a.

Also, as for the shape of the second guide surface 2b guiding the positioning abutting portion 1d of the sensor flag 1, the second guide surface 2b can be a curve protruded downward or be formed by a straight line having a relatively large inclination angle θ2 as illustrated in FIGS. 6A and 6B. This can reduce a load to cause the sensor flag 1 in the dynamic equilibrium state to move in the direction of the rotation axis 1a as much as possible.

Especially during sheet passing in which the recording medium S contacts the contact portion 1c of the sensor flag 1, the load to cause the sensor flag 1 in the dynamic equilibrium state as illustrated in FIG. 4A to move in the direction of the rotation axis 1a is reduced as much as possible. Thus, followability of the sensor flag 1 for the recording medium S can be improved.

It is to be noted that, although the above embodiment is configured to apply the elastic force of the torsion coil spring 4 at the time of returning the sensor flag 1 to the home position, the embodiment may be configured to omit the torsion coil spring 4 and return the sensor flag 1 to the home position by self weight balance of the contact portion 1c.

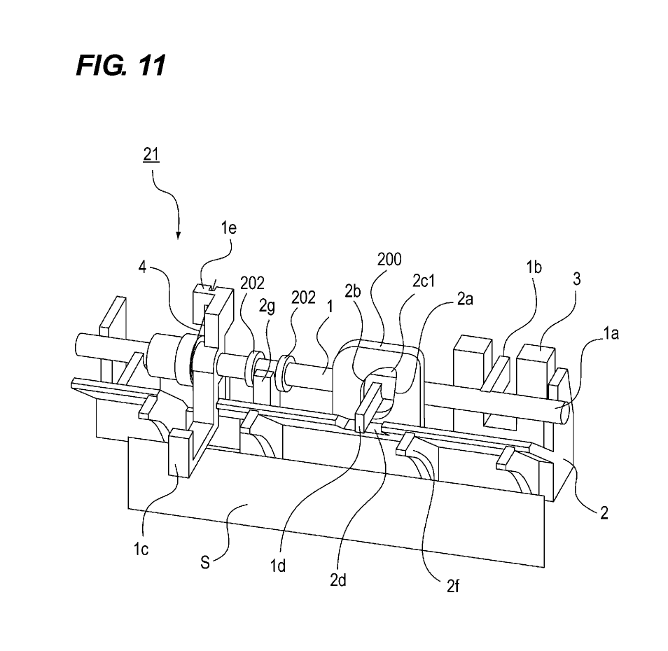

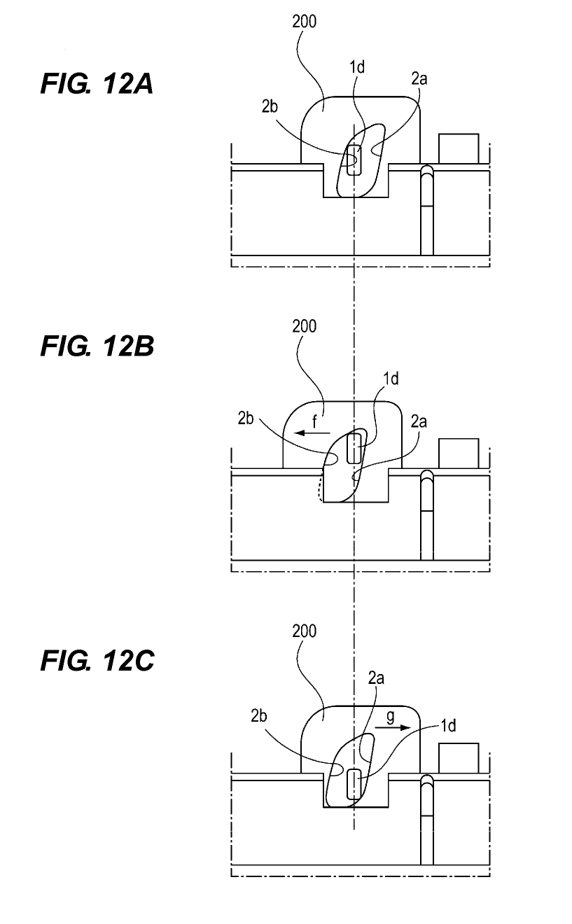

Also, although the sensor flag 1 is provided to be movable in the direction of the rotation axis 1a in the above embodiment, the sensor flag 1 may be fixed in the direction of the rotation axis 1a, and a plate-shaped member 200, on which the first guide surface 2a and the second guide surface 2b are formed, may be provided in the apparatus main body to be slidable in the direction of the rotation axis 1a. FIG. 11 is a perspective view illustrating a configuration of such a modification example, and FIG. 12 illustrates operations in this modification example. In FIGS. 11 and 12, identical components to those in the above first embodiment are illustrated with the same reference numerals, and description of the duplicate components will not be repeated.

The movement of the sensor flag 1 is regulated so that the sensor flag 1 may be prevented from moving in the direction of the rotation axis 1a by a regulating portion 202 provided at the rotation axis 1a and a positional regulating member 2g provided at the conveying guide 2. The plate-shaped member 200, on which the first guide surface 2a and the second guide surface 2b are formed, is provided in the apparatus main body to be slidable in the direction of the rotation axis 1a by a not illustrated moving portion.

FIG. 12A illustrates a state in which the sensor flag 1 is located at the home position. When the sensor flag 1 is pressed by the recording medium S and is turned from the home position, the positioning abutting portion 1d of the sensor flag 1 slides in contact with the second guide surface 2b, and along with turning of the sensor flag 1, the plate-shaped member 200 moves in the arrow f direction in FIG. 12B along the direction of the rotation axis 1a.

Also, when the recording medium S passes the sensor flag 1 to cause the sensor flag 1 to return from the detecting position to the home position, the positioning abutting portion 1d slides in contact with the first guide surface 2a, and along with turning of the sensor flag 1, the plate-shaped member 200 moves in the arrow g direction in FIG. 12C along the direction of the rotation axis 1a and returns to the home position illustrated in FIG. 12A.

### Second Embodiment

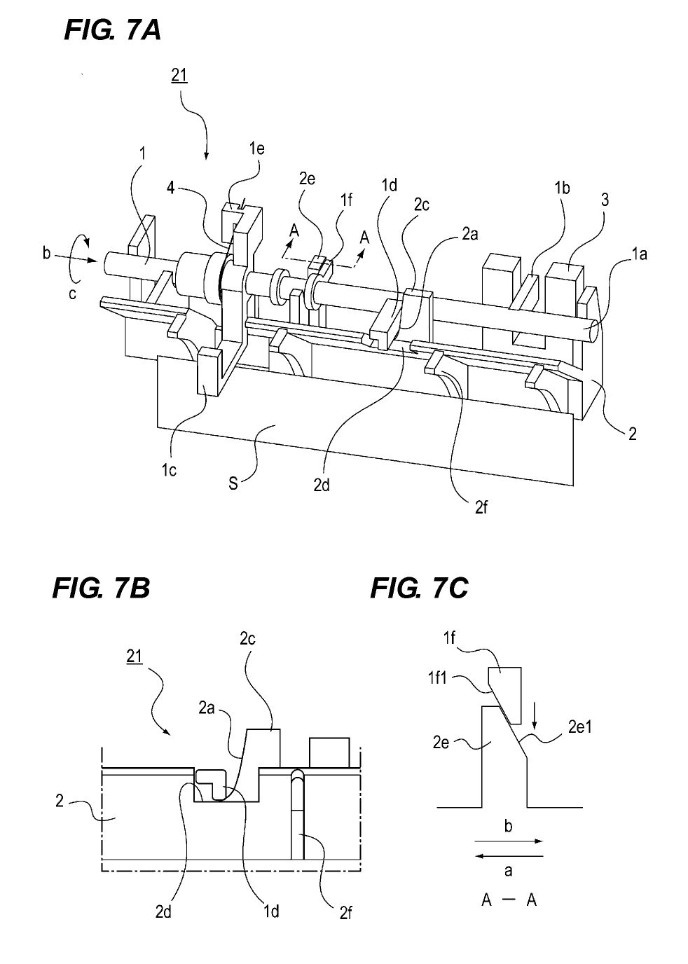

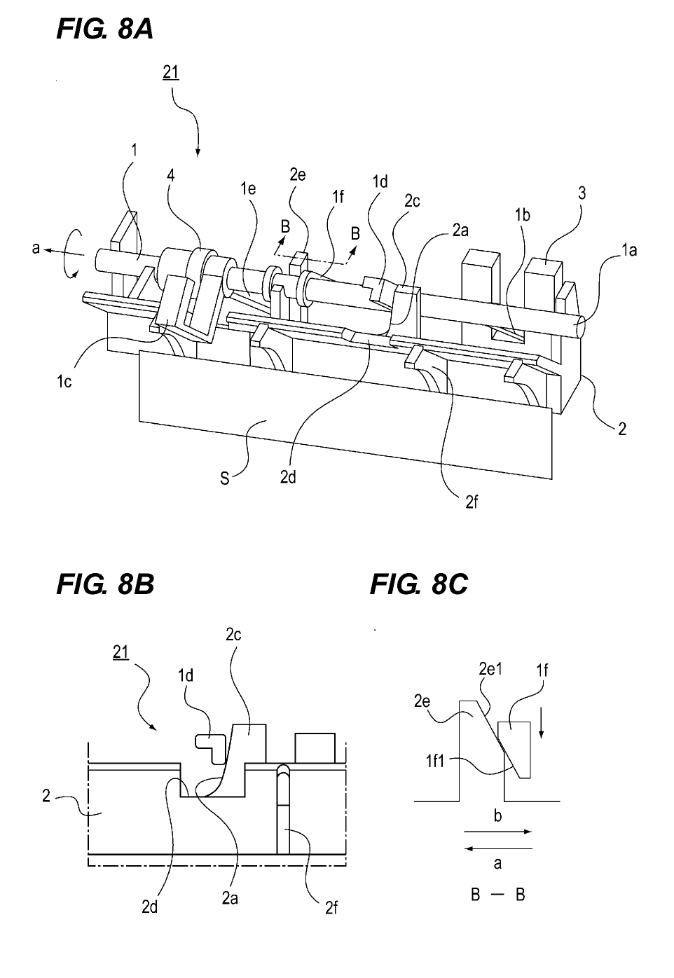

Next, a second embodiment of an image forming apparatus having a sheet detecting apparatus according to the present invention will be described with reference to FIGS. 7 and 8. It is to be noted that similar components to those in the above first embodiment are illustrated with the same reference numerals, and description of the duplicate components will not be repeated.

In the aforementioned first embodiment, the positioning abutting portion 1d of the sensor flag 1 slides in contact with the second guide surface 2b and moves. Thus, when the sensor flag 1 moves from the home position illustrated in FIG. 3A to the detecting position illustrated in FIG. 4A, the sensor flag 1 is moved in the second axial direction (arrow b direction in FIG. 3B) along the rotation axis 1a. The present embodiment shows an example of a thrusting member thrusting the sensor flag 1 in the second axial direction (arrow b direction in FIG. 7A) along the rotation axis 1a.

In this example, an inclined surface 1f1 of a positional approximating member if provided on the sensor flag 1 on the opposite side of the contact portion 1c centering on the rotation axis 1a and an inclined surface 2e1 of a thrusting member 2e standing up from the conveying guide 2 abut and slide on each other. When the sensor flag 1 is rotated centering on the rotation axis 1a and moves from the home position illustrated in FIG. 7A to the detecting position illustrated in FIG. 8A, the sensor flag 1 is moved in the second axial direction (arrow b direction in FIG. 7A) along the rotation axis 1a. In the present embodiment, the positioning abutting portion 1d and the positional approximating member if are provided on the sensor flag 1 and are protruded portions protruded in the radial direction of the sensor flag 1.

That is, the recording medium S contacts the contact portion 1c of the sensor flag 1 from the home position illustrated in FIG. 7A and presses and rotates the sensor flag 1 centering on the rotation axis 1a in the arrow c direction in FIG. 7A. The positional approximating member 1f, which turns integrally with the sensor flag 1, is then lowered from the uppermost position illustrated in FIGS. 7A and 7C. At this time, as illustrated in FIG. 7C, the inclined surface 1f1 of the positional approximating member if abuts and slides on the inclined surface 2e1 of the thrusting member 2e standing up from the conveying guide 2 and is lowered obliquely downward in the arrow b direction in FIG. 7C along the inclined surface 2e1. Accordingly, the sensor flag 1 moves in the arrow b direction in FIG. 7A as the second axial direction along the rotation axis 1a.

FIG. 8A illustrates a state in which the sensor flag 1 has been rotated to the detecting position. When the recording medium S is further conveyed, and the rear end of the recording medium S passes the contact portion 1c of the sensor flag 1, the sensor flag 1 performs a rotating operation to the home position illustrated in FIG. 7A by weight of the contact portion 1c itself and in receipt of the elastic force by expansion of the torsion coil spring 4.

At this time, as illustrated in FIG. 8A, while the positioning abutting portion 1d of the sensor flag 1 moves along the first guide surface 2a provided in the plate-shaped member 2c of the conveying guide 2, the positioning abutting portion (a first protrusion) 1d moves in a downward direction in FIG. 8A and in a left direction of the rotation axis 1a as the first axial direction (arrow a direction in FIG. 8A). Subsequently, the positioning abutting portion 1d slides on the inclined surface of the first guide surface 2a, lands on the positioning surface 2d provided on the conveying guide 2, and returns to the home position illustrated in FIG. 7A.

Meanwhile, in the aforementioned first embodiment, the through hole 2c1 is provided in the inside of the plate-shaped member 2c, and a circumference thereof is made into the first guide surface 2a and the second guide surface 2b. In the present embodiment, one side edge of the plate-shaped member 2c is formed as the first guide surface 2a having a surface inclined to the direction of the rotation axis 1a in a similar manner to that of the aforementioned first embodiment. The inclination angle θ1 of the first guide surface 2a of the present embodiment is also set to be smaller as the positioning abutting portion 1d moves closer to the home position.

The positional approximating member (a second protrusion) 1f, which turns integrally with the sensor flag 1, is raised from the lowermost position illustrated in FIG. 8C. At this time, the inclined surface 1f1 of the positional approximating member if abuts and slides on the inclined surface 2e1 of the thrusting member 2e standing up from the conveying guide 2 and is raised obliquely upward in the arrow a direction in FIG. 8C along the inclined surface 2e1. Accordingly, the sensor flag 1 moves in the arrow a direction in FIG. 8A as the first axial direction along the rotation axis 1a and returns to the home position illustrated in FIG. 7A.

In the present embodiment, the sensor flag 1 moves from the home position illustrated in FIG. 7A to the detecting position illustrated in FIG. 8A. At this time, the sensor flag 1 is moved in the second axial direction (arrow b direction in FIG. 7A) along the rotation axis 1a. To do so, the present embodiment is configured so that the inclined surface 1f1 of the positional approximating member if provided in the sensor flag 1 may abut and slide on the inclined surface 2e1 of the thrusting member 2e provided in the conveying guide 2 to cause the positional approximating member if to move obliquely.

The sensor flag 1 moves from the detecting position illustrated in FIG. 8A to the home position illustrated in FIG. 7A. At this time, the sensor flag is moved in the first axial direction (arrow a direction in FIG. 8A) along the rotation axis 1a. To do so, the present embodiment is configured so that the positioning abutting portion 1d provided in the sensor flag 1 may slide and move in contact with the first guide surface 2a of the plate-shaped member 2c provided in the conveying guide 2.

Although a configuration in which the inclined surface 2e1 of the thrusting member 2e and the inclined surface 1f1 of the positional approximating member if slide in contact with each other is taken as an example, a part of the positional approximating member if which slides in contact with the inclined surface 2e1 of the thrusting member 2e may not be inclined. Also, although a configuration in which the first guide surface 2a formed in the plate-shaped member 2c inclined to the direction of the rotation axis 1a and the positioning abutting portion 1d slide in contact with each other is taken as an example, a part inclined to the direction of the rotation axis 1a may be provided in the positioning abutting portion 1d of the sensor flag 1, and a part of the plate-shaped member 2c which contacts the positioning abutting portion 1d may not be inclined.

In this manner, the present embodiment is configured to separate the configurations to move the sensor flag 1 in the first and second axial directions along the rotation axis 1a. Even in a case where a moving portion of the sensor flag 1 in the direction of the rotation axis 1a is separated, a similar effect can be exerted. Other configurations are similar to those in the aforementioned first embodiment and can exert similar effects.

### Reference Example

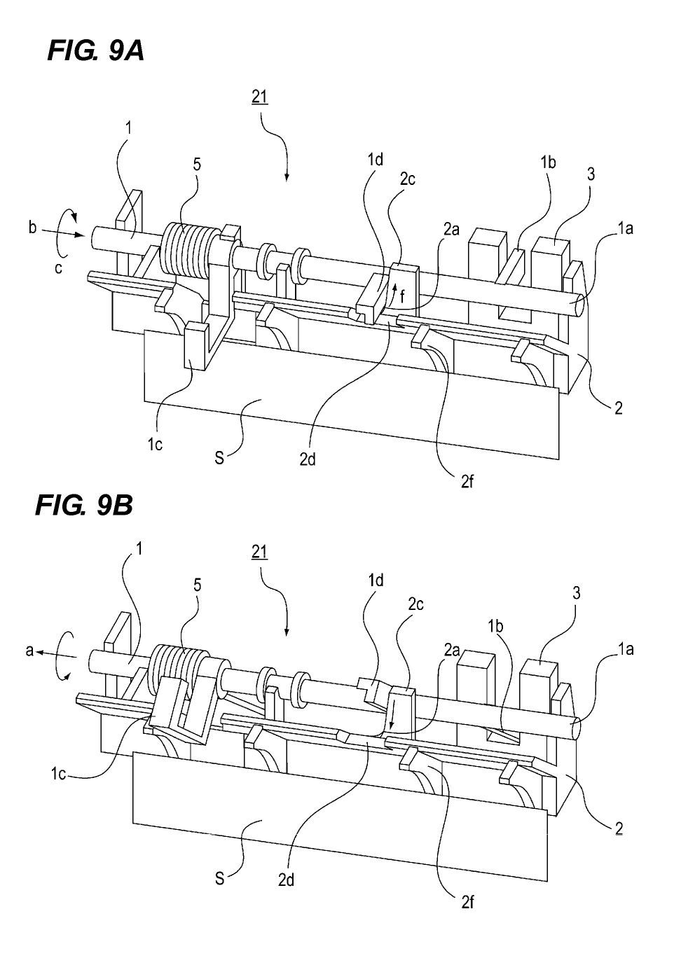

Next, a reference example of an image forming apparatus having a sheet detecting apparatus will be described with reference to FIG. 9. It is to be noted that similar components to those in the above embodiments are illustrated with the same reference numerals, and description of the duplicate components will not be repeated. In the present reference example, the sensor flag 1 moves from the home position illustrated in FIG. 9A to the detecting position illustrated in FIG. 9B. The present reference example is provided with a thrusting member thrusting the sensor flag 1 in the arrow b direction in FIG. 9A (second axial direction) along the rotation axis 1a at the time of moving from the home position to the detecting position. The thrusting member is formed with use of a thrusting force of a compression spring 5, which is locked by a part of the conveying guide 2 at one end thereof and is slidably brought into pressure contact with a part of the sensor flag 1 at the other end thereof.

The thrusting force of the compression spring 5 is controlled to have a minor value not to prevent turning of the sensor flag 1. An example of the compression spring 5 can be formed by externally covering the rotation axis 1a with a coiled spring, locking one end of the coiled spring at a part of the conveying guide 2, and making the other end abut on a flange member provided in the rotation axis 1a.

FIG. 9A illustrates a state in which the sensor flag 1 at the home position is thrust in the arrow b direction in FIG. 9A (second axial direction) by the thrusting force of the compression spring 5, and in which the positioning abutting portion 1d always receives a force in the right direction in FIG. 9A toward the first guide surface 2a of the plate-shaped member 2c provided in the conveying guide 2.

Thereafter, the recording medium S is conveyed upward in FIG. 9A along the guide rib 2f of the conveying guide 2. Subsequently, at the same time as the contact portion 1c is pressed up, the positioning abutting portion 1d of the sensor flag 1 receives a force of the compression spring 5 and moves in the arrow f direction in FIG. 9A (upper right direction in FIG. 9A) along the first guide surface 2a.

When the recording medium S is further conveyed, and the rear end of the recording medium S passes the contact portion 1c, the positioning abutting portion 1d of the sensor flag 1 slides along and in contact with the first guide surface 2a by weight of the contact portion 1c itself and heads for the home position illustrated in FIG. 9A.

In this manner, since the positioning abutting portion 1d of the sensor flag 1 slides along and in contact with the first guide surface 2a and always receives the thrusting force of the compression spring 5, chattering can be prevented, and a collision noise of the sensor flag 1 at the positioning abutting portion 1d can be alleviated drastically.

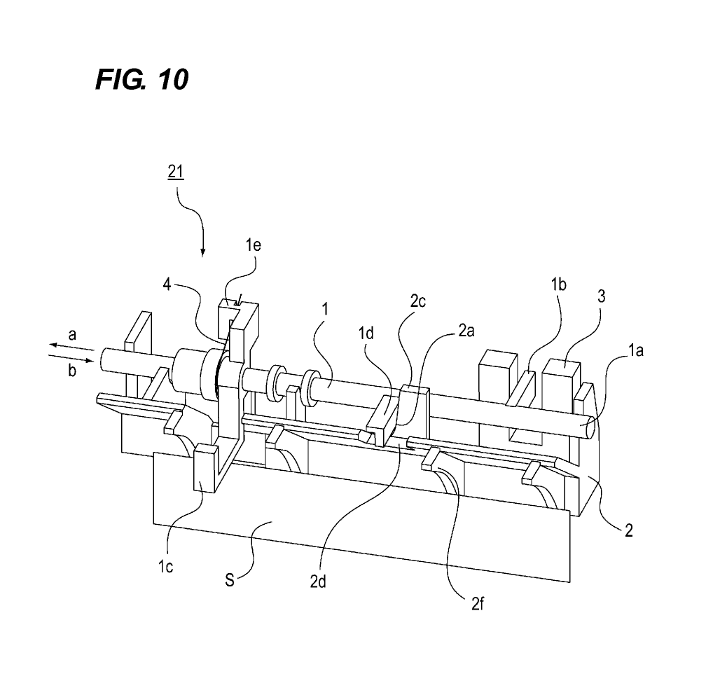

Meanwhile, instead of the compression spring 5, the torsion coil spring 4 is arranged obliquely to the direction of the rotation axis 1a of the sensor flag 1 as illustrated in FIG. 10. That is, positions of one end and the other end of the torsion coil spring 4 receiving applied forces are arranged to be displaced in the axial direction. Especially, the positions are arranged so that the distance in the axial direction between one end and the other end of the torsion coil spring 4 may be longer than the height of the torsion coil spring 4. By doing so, the elastic force by expansion of the torsion coil spring 4 acts in the direction of the rotation axis 1a as well, and thus a similar effect to that of the aforementioned compression spring 5 can be exerted.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-039354, filed Feb. 25, 2011, which is hereby incorporated by reference herein in its entirety.

What is claimed is:

1. A sheet detecting apparatus comprising:
a turning portion turning from a home position to a detecting position by being pressed by a conveyed sheet and having a protruded portion protruded in a radial direction;
a sensor outputting a detection signal in response to turning of the turning portion to the detecting position;
a first sliding contact portion sliding in contact with the protruded portion so as to move relatively to the protruded portion in an axial direction of the turning portion when the turning portion returns from the detecting position to the home position; and
a second sliding contact portion sliding in contact with the protruded portion so as to move relatively to the protruded portion in the axial direction of the turning portion when the turning portion turns from the home position to the detecting position.

2. The sheet detecting apparatus according to claim 1, wherein the turning portion is movable in the axial direction, and the first sliding contact portion and the second sliding contact portion have surfaces inclined to the axial direction,
wherein, when the turning portion moves from the detecting position to the home position, the first sliding contact portion slides with the protruded portion to cause the turning portion to move in a first axial direction, and
wherein, when the turning portion moves from the home position to the detecting position, the second sliding contact portion slides with the protruded portion to cause the turning portion to move in a second axial direction, which is an opposite direction of the first axial direction.

3. The sheet detecting apparatus according to claim 2, wherein the protruded portion has a first protrusion that contacts with first sliding contact portion and a second protrusion that contacts with second sliding contact portion.

4. The sheet detecting apparatus according to claim 1, wherein an inclination angle of the first sliding contact portion to the axial direction is formed to be smaller as the turning portion moves closer to the home position.

5. An image forming apparatus comprising:
an image forming portion forming an image on a sheet; and
the sheet detecting apparatus according to claim 1 detecting the sheet on which the image is formed by the image forming portion.

6. The image forming apparatus according to claim 5, wherein the turning portion is movable in the axial direction, and the first sliding contact portion and the second sliding contact portion have surfaces inclined to the axial direction,
wherein, when the turning portion moves from the detecting position to the home position, the first sliding contact portion slides with the protruded portion to cause the turning portion to move in a first axial direction, and
wherein, when the turning portion moves from the home position to the detecting position, the second sliding contact portion slides with the protruded portion to cause the turning portion to move in a second axial direction, which is an opposite direction of the first axial direction.

7. The sheet detecting apparatus according to claim 6, wherein the protruded portion has a first protrusion that contacts with first sliding contact portion and a second protrusion that contacts with second sliding contact portion.

8. The image forming apparatus according to claim 6, wherein an inclination angle of the first sliding contact portion to the axial direction is formed to be smaller as the turning portion moves closer to the home position.
